(19) United States
(12) Patent Application Publication
(10) Pub. No.: US 2015/0206672 A1
(43) Pub. Date: Jul. 23, 2015

(54) KEYBOARD, ADJUSTED KEYBOARD ACCORDING TO USER OPERATION AND CONDUCTING STRENGTH ADJUSTMENT METHOD ACCORDING TO USER OPERATION

(71) Applicants: Darfon Electronics (Suzhou) Co., Ltd., Jiangsu Province (CN); Darfon Electronics Corp., Taoyuan (TW)

(72) Inventor: Te-Ping Hsu, Taoyuan City (TW)

(73) Assignees: DARFON ELECTRONICS CORP., Taoyuan (TW); DARFON ELECTRONICS (SUZHOU) CO., LTD., Jiangsu Province (CN)

(21) Appl. No.: 14/597,251

(22) Filed: Jan. 15, 2015

(30) Foreign Application Priority Data
Jan. 17, 2014 (TW) 103101784

(51) Int. Cl. H01H 13/70

(52) U.S. Cl. CPC H01H 13/70

(57) ABSTRACT

A keyboard comprising a plurality of keys and a keyboard controller is disclosed. The keys contain a first key. The keyboard controller generates a first sensing value corresponding to the first key when the first key is pressed by a first force. The first sensing value is related to the magnitude of the first force and is compensated by a first compensation value corresponding to the first key to generate a first adjusted sensing value. If the first adjusted sensing value is higher than or equal to a current threshold, the keyboard controller determines that the first key is pressed and accordingly outputs a first key code corresponding to the first key.

This application claims the benefit of Taiwan application Serial No. 103101784, filed Jan. 17, 2014, the subject matter of which is incorporated herein by reference.

### BACKGROUND OF THE INVENTION

1. Field of the Invention

The invention relates in general to a keyboard and control method thereof, and more particularly to a keyboard capable of adjusting key conducting strength and a control method thereof.

2. Description of the Related Art

Nowadays, keyboard has been widely used and become a most popular input device among computer peripherals. However, the quality of the keyboard may vary with the manufactures, and each key on the keyboard may have a different conducting strength. Therefore, in the respect of the conducting strength of a, how to make the keyboard have higher uniformity of quality and adjustable in response to user's needs has become a prominent task for the industries.

### SUMMARY OF THE INVENTION

According to one embodiment of the present invention, a keyboard comprising a plurality of keys and a keyboard controller is disclosed. The keys comprise a first key. The keyboard controller generates a first sensing value corresponding to the first key when the first key is pressed by a first force. The first sensing value is related to the magnitude of the first force and is compensated by a first compensation value corresponding to the first key to generate a first adjusted sensing value. If the first adjusted sensing value is higher than or equal to a current threshold, the keyboard controller determines whether the first key is pressed and outputs a first key code corresponding to the first key accordingly.

According to another embodiment of the present invention, a keyboard control method comprising a sensing procedure is disclosed. The sensing procedure comprises following steps. A keyboard comprising a plurality of keys containing a first key is provided, wherein a first sensing value corresponding to the first key is generated when the first key is pressed by a first force. The first sensing value is related to the magnitude of the first force and is compensated by a first compensation value corresponding to thirst key to generate a first adjusted sensing value. If the first adjusted sensing value is higher than or equal to a current threshold, the keyboard determines that the first key is pressed, and outputs a first key code corresponding to the first key.

According to an alternate embodiment of the present invention, a keyboard capable of adjusting key conducting strength according to a user operation is disclosed. The keyboard comprises a plurality of keys and a keyboard controller. The keys comprise a first key. The keyboard controller generates a first sensing value corresponding to the first key when the first key is pressed by a first force, and compensates the first sensing value by a first compensation value corresponding to the first key to generate a first adjusted sensing value. The keyboard controls an actuation threshold of the first key through the adjustment of a current threshold. If the first adjusted sensing value is higher than the actuation threshold, then a first key code corresponding to the first key is outputted.

According to another alternate embodiment of the present invention, a keyboard comprising a first key, a first path, a second key, a second path, and a keyboard controller is disclosed. When the first key is pressed by a first force, the first path correspondingly transmits a first signal. When the second key is pressed by the first force, the second path correspondingly transmits a second signal. The keyboard controller stores a first compensation value, a second compensation value, an actuation threshold, a first key code and a second key code, and is capable of extracting a first signal value and a second signal value from the first signal and the second signal respectively. When the keyboard controller receives the first signal from the first path and the computation result of the first signal value and the first compensation value satisfies the actuation threshold, the keyboard controller outputs a first key code to a host in response to the first signal. When the keyboard controller receives the second signal from the second path and the computation result of the second signal value and the second compensation value satisfies the actuation threshold, the keyboard controller outputs a second key code to the host in response to the second signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a keyboard according to an embodiment of the present invention.

FIG. 2A is a schematic diagram of a keyboard on which each of the keys comprises a plurality of sub-contact points according to an embodiment of the present invention.

FIG. 2B is a schematic diagram of four key switches on a switch film layer corresponding to four adjacent keys on the keyboard according to an embodiment of the present invention.

FIG. 3A is an equivalent circuit diagram of the key “1” of FIG. 1.

FIG. 3B is another equivalent circuit diagram of the key “1” of FIG. 1.

FIG. 4 is a schematic diagram of four keys “1”, “2”, “Q”, and “W” using a piezoresistive material component according to an embodiment of the present invention.

FIGS. 5A-5B are equivalent circuit diagrams of a keyboard according to an embodiment of the present invention.

FIG. 6 is a schematic diagram of corresponding overall equivalent impedance values of a current path when the keys K_{—}1, K_Q and K_W of FIGS. 5A-5B are pressed.

FIG. 7 is a schematic diagram of digit values obtained by performing analog to digital conversion on correspondingly transmitted current values when a predetermined calibration strength is applied on the keys K_{—}1, K_Q and K_W of FIG. 6.

FIG. 8 is a schematic diagram of digit values obtained by compensating the calibration sensing values of the keys K_{—}1, K_Q and K_W of FIG. 7 by corresponding compensation values and a calibration threshold TH1.

FIG. 9 is a schematic diagram of compensated digit value of each of the keys obtained after the user increased the current threshold to threshold TH2 (0.8 A) and applied a force of 80 g on each of the keys K_{—}1, K_Q and K_W.

FIG. 10 is a schematic diagram of compensated digit value of each of the keys obtained after the user decreased the current threshold to threshold TH2 (0.6 A) and applied a force of 60 g on each of the keys K_{—}1, K_Q and K_W.

FIG. 11 is a schematic diagram of compensated digit values obtained after a force of 80 g is applied on each of the keys K_{—}1, K_Q and K_W when the keys K_{—}1, K_Q and K_W have different thresholds.

### DETAILED DESCRIPTION OF THE INVENTION

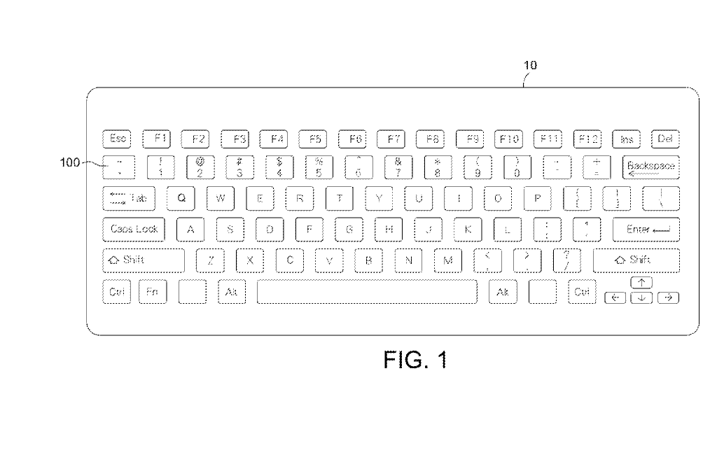

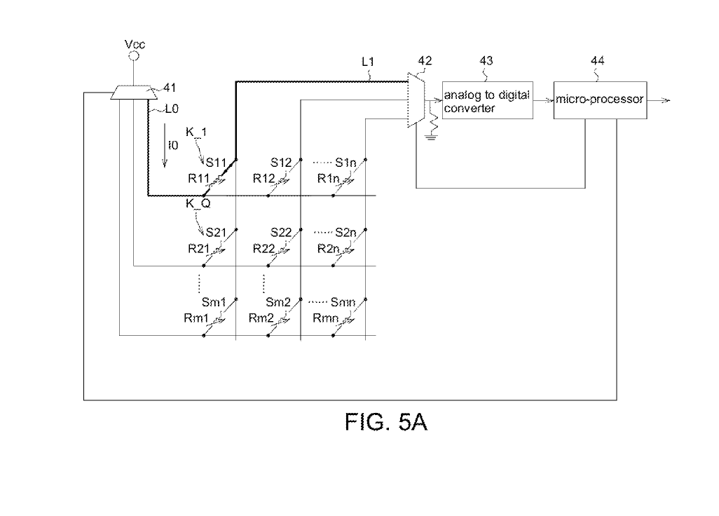

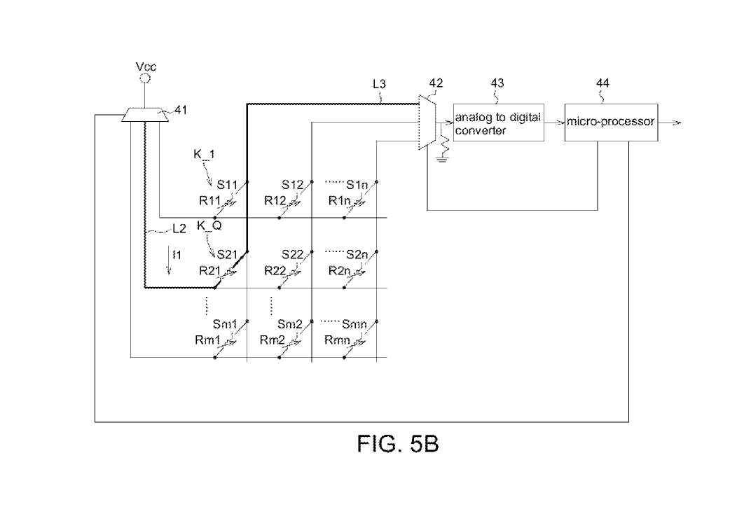

Referring to FIG. 1, a schematic diagram of a keyboard according to an embodiment of the present invention is shown. The keyboard 10 comprises a plurality of keys 100 and a keyboard controller (such as the micro-processor 44 of FIG. 5A). When a key 100 is pressed by a force, the keyboard controller: (1) generates a sensing value corresponding to the key 100, wherein the sensing value is related to the magnitude of the force; (2) compensates the sensing value by a compensation value corresponding to the key 100 to generate an adjusted sensing value; (3) determines that the key 100 is pressed and accordingly outputs a key code corresponding to the key 100 if the adjusted sensing value is higher than or equal to a current threshold.

In the present embodiment, through the adjustment of a current threshold, the keyboard 10 is capable of adjusting the conducting strength of the key 100 according to the user's needs to increase the adaptability, and flexibility and convenience of the keyboard 10. Moreover, the conducting strength of the keys on the keyboard 10 manufactured according to the embodiments of the present invention have higher uniformity. Details of the invention are disclosed below.

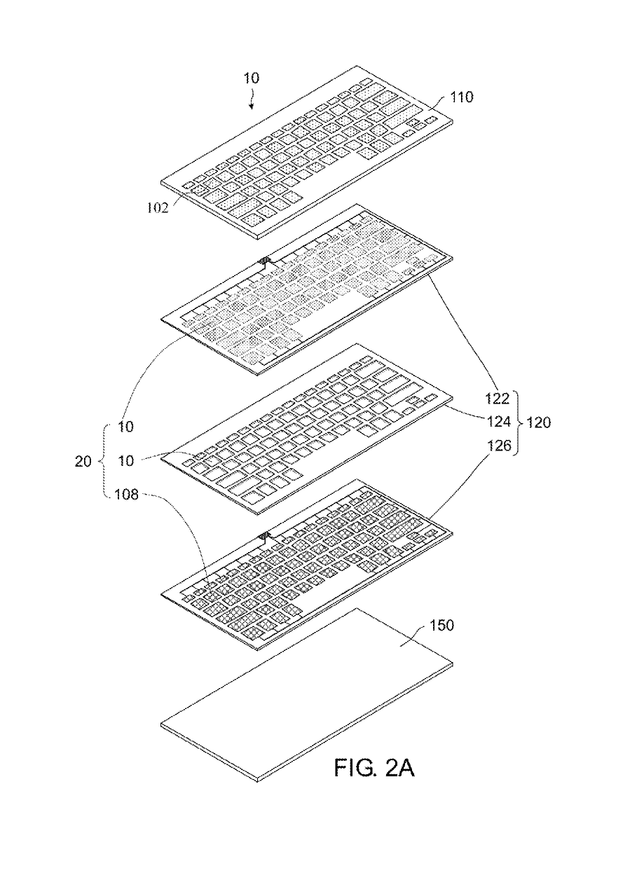

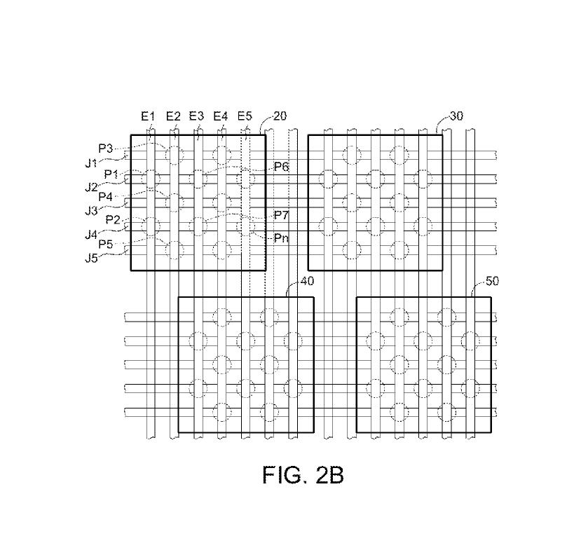

The present embodiment discloses two approaches of key design in which a sensing value related to the magnitude of a force is generated when the key 100 is pressed by a force. The first approach of key design is illustrated in FIGS. 2A-2B, and detailed structures of the key of the first approach of key design is disclosed in Taiwanese Patent Application No. 102214524. FIG. 2A is a schematic diagram of a keyboard on which each of the keys comprises a plurality of sub-contact points according to an embodiment of the present invention. Each sub-contact point comprises an upper electrode and a lower electrode separated from each other. As indicated in FIG. 2A, the keyboard 10, having a plurality of keys disposed thereon, comprises a keycap layer 110, a switch film layer 120, and a substrate 150. The switch film layer 120 comprises an upper film circuit layer 122, a lower film circuit layer 126 and an isolation layer 124. The keycap area disposed on the keycap layer 110 and can be pressed by the user. Each keycap area is aligned with a key switch of the switch film layer 120. For example, the keycap area 102 is aligned with the key switch 20 of the switch film layer 120, wherein the key switch 20 comprises a corresponding area 104 of the upper film circuit layer 122, a corresponding area 108 of the lower film circuit layer 126, and an area 106 of the isolation layer 124.

Referring to FIG. 2B, a schematic diagram of four key switches on a the switch film layer 120 corresponding to four adjacent keys on the keyboard 10 according to an embodiment of the present invention is shown. Let four adjacent keys “1”, “2”, “Q”, and “W” respectively corresponding to key switches 20, 30, 40 and 50 be taken for example. The upper film circuit layer 122 comprises a plurality of upper electrodes such as upper electrodes E1˜E5. The upper electrodes are formed on a lower surface of the upper film circuit layer 122 and arranged in a strip shape and extend along a first direction, for example, along a vertical direction. The lower film circuit layer 126 comprises a plurality of lower electrodes such as lower electrodes J1˜J5. The lower electrodes are formed on an upper surface of the lower film circuit layer 126 and arranged in a strip shape and extend along a second direction, for example, along a horizontal direction. The first direction is not parallel to the second direction so that a plurality of intersections can be formed.

As indicated in FIG. 2B, on the switch film layer 120, the single key “1” corresponds to the key switch 20, the single key “2” corresponds to the key switch 30, the single key “Q” corresponds to key switch 40, and the single key “W” corresponds to key switch 50. In addition, the switch film layer 120 comprises a plurality of sub-contact points P1-Pn corresponding to the key switch 20 of the single key “1”. For example: the sub-contact point P1 is located at the intersection between the upper electrode E1 and the lower electrode J2. Before the key “1” is pressed, none of the sub-contact points P1-Pn is conducted. Let the sub-contact point P1 be taken for example. The upper electrode E1 and the lower electrode J2 are vertically separated from each other and both are not conducted. Conversely, when the key “1” is pressed, some of the sub-contact points P1-Pn, after receiving the strength applied by the key “1”, will be squeezed and become conducted. The number of conducted sub-contact points is related to the magnitude of the force applied on the key “1”.

To be more specifically, as indicated in FIG. 2B, the sub-contact points P1˜P2 are located on the upper electrode E1, the sub-contact points P3˜P5 are located on the upper electrode E2, and the sub-contact points P6˜P7 are located on the upper electrode E3. When the key “1” is pressed to squeeze some of the sub-contact points, the upper and lower electrodes corresponding to the pressed sub-contact points are close to each other or even contact each other and make the pressed sub-contact points conducted. For example, when the user presses the key “1” with a weaker strength, the keycap layer 110 corresponding to the keycap area 102 of the key “1” will have a smaller motion or deformation. Under such circumstance, the upper film circuit layer 122 of the switch film layer 120 of the key switch 20 corresponding to the key “1” contacts the lower film circuit layer 126 by a smaller contact area and can only press and make a smaller amount of sub-contact points conducted. Conversely, when the user presses the key “1” with a stronger strength, the keycap layer 110 corresponding to the keycap area 102 of the key “1” will have a larger motion or deformation. Under such circumstance, the upper film circuit layer 122 of the switch film layer 120 of the key switch 20 corresponding to the key “1” contacts the lower film circuit layer 126 by a larger contact area, and can press a and make a larger amount of sub-contact points conducted. Thus, through the adjustment in the force applied on the key “1”, the number of conducted sub-contact points of the key switch 20 can be changed and the resistance corresponding to the key “1” can also be changed accordingly.

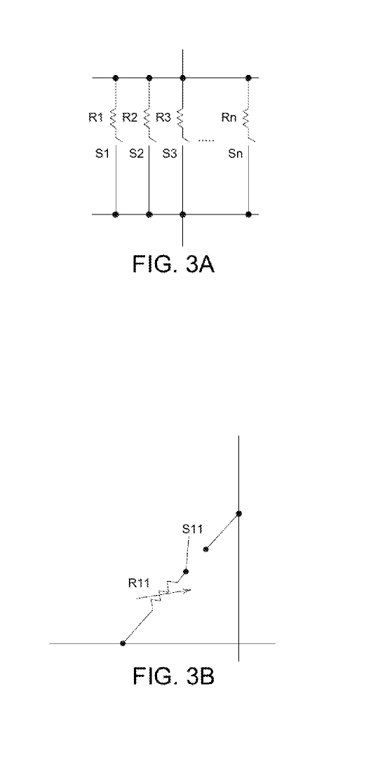

As indicated in the circuit diagram, the sub-contact points can respectively be realized by components such as resistors and switches. FIG. 3A shows an equivalent circuit diagram of the key “1” of FIG. 1. The sub-contact points P1-Pn are respectively equivalent to sub-resistors R1-Rn and sub-switches S1-Sn. The sub-resistors R1-Rn are electrically coupled to the sub-switches S1-Sn respectively. When the sub-contact points are conducted, the corresponding sub-switches will also be conducted. When the key “1” is pressed by a weaker force F1, the contact area is smaller.

Therefore, a smaller amount of sub-contact points are conducted, and accordingly a smaller amount of sub-switches are conducted. For example, the sub-switches S1-S3 are conducted. When the key “1” is pressed by a stronger force F2, the contact area is larger. Therefore, a larger amount of sub-switches with parallel-connection are conducted. For example, the sub-switches S1-Sn are connected. The equivalent circuit diagram of the key “1” of FIG. 3A can also be equivalent to the equivalent circuit diagram of FIG. 3B in which a variable resistor R11 and a switch S11 are illustrated, wherein, the resistance of the variable resistor R11 is related to the resistance of sub-resistors corresponding to the conducted sub-switches.

Therefore, different forces can make the overall key “1” generate different resistances R11. When the force makes the corresponding adjusted sensing value higher than the current threshold, the keyboard outputs a key code corresponding to the key “1”.

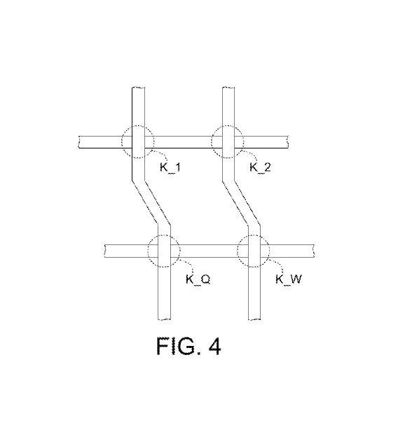

The second approach of key design uses a piezoresistive material component in the key. Referring to FIG. 4, a schematic diagram of four keys “1”, “2”, “Q”, and “W” using a piezoresistive material component according to an embodiment of the present invention is shown. The keys “1”, “2”, “Q”, and “W” are represented by K_{—}1, K_{—}2, K_Q, and K_W, respectively. The resistance of the piezoresistive material varies with the force applied thereon. The impedance value of the piezoresistive material component of the key is related to the magnitude of the force. As indicated in FIG. 4, the piezoresistive material is equivalent to a variable resistor. When a key is pressed, the resistance of the variable resistor will change according to the magnitude of the force applied on the key. The key using a piezoresistive material component according to the second approach of key design can be equivalent to a variable resistor and a switch. For example, the circuit of FIG. 3B can also be used as an equivalent circuit of the key “1” of the second approach of key design. When the adjusted sensing value corresponding to the force is higher than the current threshold, the keyboard outputs a key code corresponding to the key.

The reasons why the keys at different positions of the keyboard have different impedance values are disclosed below. Referring to FIGS. 5A-5B, equivalent circuit diagrams of a keyboard 10 according to an embodiment of the present invention are shown. Each of the keys is equivalent to a variable resistor and a switch. For example, the key “1” (represented by K_{—}1) is equivalent to a variable resistor R11 and a switch S11, and the key “Q” (represented by K_Q) is equivalent to a variable resistance R21 and a switch S21. The keyboard 10 further comprises a first multiplexer 41, a second multiplexer 42, an analog to digital converter 43 and a micro-processor 44. The micro-processor 44 is capable of executing the function of the keyboard controller for sequentially scanning all keys on the keyboard. Refer to FIG. 5A. When (1) the key K_{—}1 is pressed, the switch S11 is conducted, and (2) the micro-processor 44 scans the key K_{—}1 (that is, the first multiplexer 41 selectively conducts the trace L0 and the second multiplexer 42 selectively conducts the trace L1), the voltage source Vcc transmits the current I0 corresponding to the key K_{—}1 to the second multiplexer 42 through the trace L0 and the trace L1. Meanwhile, the overall impedance value of the key K_{—}1 conducted by the current I0 is related to the variable resistance R11, the length of the trace L0 and the length of the trace L1. Then, the current I0 flows through the second multiplexer 42, and the analog to digital converter 43 converts the current I0 into a digital signal and further transmits the digital signal to the micro-processor 44.

Similarly, as indicated in FIG. 5B, when (1) the key K_Q is pressed, the switch S21 is conducted, and (2) the micro-processor 44 scans the key K_Q (that is, the first multiplexer 41 selectively conducts the trace L2 and the second multiplexer 42 selectively conducts the trace L3), the voltage source Vcc transmits a current I1 corresponding to the key K_Q to the second multiplexer 42 through the trace L2 and the trace L3. Meanwhile, the overall impedance value of the key K_Q conducted by the current I1 is related to the variable resistance R21, the length of the trace L2 and the length of the trace L3. Then, the current I1 flows through the second multiplexer 42, and the analog to digital converter 43 converts the current I1 into a digital signal and further transmits the digital signal to the micro-processor 44.

Since the total length of the traces L0 and L1 is different from that of the traces L2 and L3, the impedance value of the key K_{—}1 is also different from that of the key K_Q. Since the position of each key on the keyboard is different, the overall length of corresponding traces of each key is also different, and accordingly, when a key is conducted, the overall impedance value of the traces through which the current flows is also different. Suppose the voltage source provided to the key has the same voltage, that is, voltage Vcc. When the user presses different keys with the same force, the currents generated correspondingly will be different because the overall impedance value of each key is different, and the corresponding digit value outputted from the analog to digital converter 43 will also be different. That is, although the force applied on different keys is the same, different keys will generate different overall equivalent impedance values and different digit values.

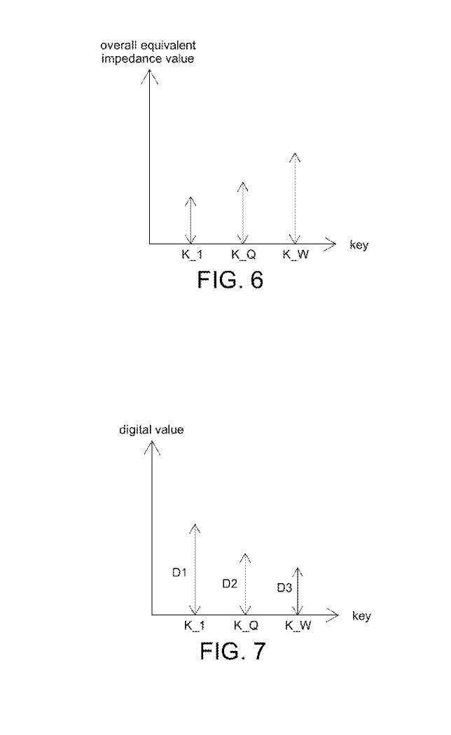

FIG. 6 is a schematic diagram of corresponding overall equivalent impedance values of a current path when the keys K_{—}1, K_Q and K_W of FIGS. 5A-5B are pressed. When the key K_{—}1 is pressed, the corresponding overall equivalent impedance value of the key K_{—}1 is related to the sum of impedance values of the traces L0 and L1. Similarly, when the key K_Q is pressed, the corresponding overall equivalent impedance value is related to the sum of impedance values of the traces L2 and L3. Since the position of each key on the keyboard is different, the overall length of corresponding traces of each key is also different, and accordingly the overall impedance value of corresponding traces is also different. Therefore, although the user presses different keys with the same force, the overall impedance value of each key is different. As indicated in FIG. 6, although the forces applied on the keys K_{—}1, K_Q and K_W are the same, the overall equivalent impedance values correspondingly generated are not the same.

Referring to FIG. 7, a schematic diagram of digit values obtained by performing analog to digital conversion on correspondingly transmitted current values when a predetermined calibration strength is applied on the keys K_{—}1, K_Q and K_W of FIG. 6 is shown. Details of one approach for generating the digit value are disclosed below. Firstly, a predetermined calibration strength is applied on all keys respectively, the same voltage Vcc is applied between two terminals (such as between the first multiplexer 41 and the second multiplexer 42) of the traces through which the conducting current of each key flows. Then, the magnitude of the current flowing through the key (such as the current I0 corresponding to the key K_{—}1) is measured. Then, the magnitude of the current is converted into a digital value by an analog to digital converter (ADC). Thus, the current values D1, D2 and D3 of the keys K_{—}1, K_Q and K_W are obtained. Basically, the current value of a key is inversely proportional to the equivalent impedance value of the key. However, the implementation of the invention is not necessarily limited to the measurement of the current values, and other approaches for generating the digit values through the calculation of voltages can also be used in the present embodiment.

The micro-processor 44 can execute a calibration procedure on the keyboard 10 to correct the above situation that different keys correspond to different overall equivalent impedance values. The calibration procedure is exemplified below with the numerical values illustrated in Table 1.

Firstly, as indicated in Table 1 and Table 2, a predetermined calibration strength S1 of 70 grams (g) is respectively applied on a plurality of keys of the keyboard, wherein the current value of the predetermined calibration threshold TH1 is 0.7 A. The micro-processor 44 scans each key (sequentially creates current paths L0, L1, L2, L3, . . . as indicated in FIG. 5A-5B) to generate several calibration sensing values respectively corresponding to the keys. The calibration sensing values are such as digit values D1 (I measurement _{—}1 is 0.6 A), D2 (I measurement _Q is 0.5 A), and D3 (I measurement _W is 0.4 A) respectively corresponding to the key K_{—}1, K_Q and K_W of FIG. 7. As indicated in Table 1 to Table 7, when a key is conducted, the coil part through which the current flows corresponds to path R, and the switch through which the current flows (that is, variable resistor) is switch R, I measurement represents calibration sensing value, I compensation represents compensation value.

TABLE 1

| Predetermined | | | |
|---|---|---|---|
| calibration strength | | | |
| S1 = 70 g, | | | |
| Threshold TH1 = 0.7 A | | | |
| I compensation | Key K_1 | Key K_Q | Key K_W |
| Vcc | 6 | 6 | 6 |
| Path R (coil portion) | 8 | 10 | 13 |
| Switch R | 2 | 2 | 2 |
| (variable resistor) | | | |
| I measurement (A) | I measurement_1 = 0.6 | I measurement_Q = 0.5 | I measurement_W = 0.4 |
| TH1 (A) | 0.7 | 0.7 | 0.7 |
| I compensation | I compensation_1 = 0.1 | I compensation_Q = 0.2 | I compensation_W = 0.3 |

TABLE 2

| | Impedance value of the force of switch |
|---|---|
| | R |
| Calibration strength S1 = 70 g | 2 |
| User's strength S2 = 80 g | 1 |
| User's strength S3 = 60 g | 3 |

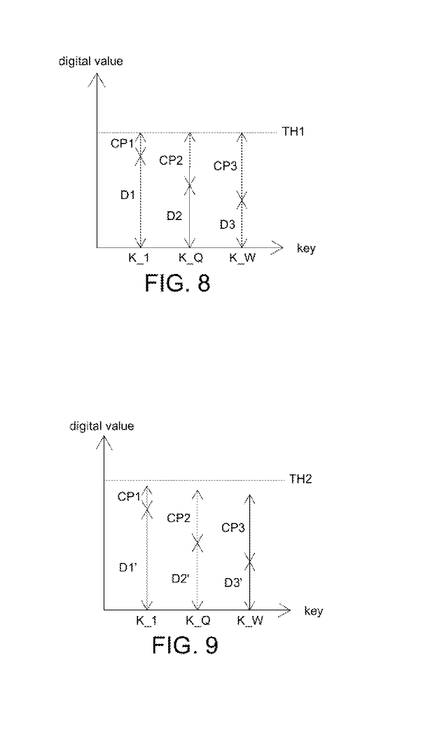

Referring to FIG. 8, a schematic diagram of digit values obtained by compensating the calibration sensing values of the keys K_{—}1, K_Q and K_W of FIG. 7 by corresponding compensation values and a calibration threshold TH1 (0.7 A) is shown. As indicated in FIG., a threshold TH1 (0.7 A) is used as a calibration threshold, and the differences obtained by deducting the threshold TH1 by calibration sensing values D1, D2 and D3 respectively are compensation values corresponding to the keys K_{—}1, K_Q and K_W respectively. That is, the sum of the compensation values of a key plus the corresponding calibration sensing value of the key is equal to the threshold TH1. For example, the compensation value CP1 of the key K_{—}1 is I compensation _{—}1 being 0.1 A which is obtained by deducting the threshold TH1 by the calibration sensing value D1; the compensation value CP2 of the key K_Q is I compensation _Q being 0.2 A which is obtained by deducting the threshold TH1 by the calibration sensing value D2; the compensation value CP3 of the key K_W is I compensation _W being 0.3 A which is obtained by deducting the threshold TH1 by the calibration sensing value D3. Then, the compensation value of each of the keys, the actuation threshold, and the key code of each of the keys are stored in the keyboard controller.

Through the calibration procedure, when each of the keys K_{—}1, K_Q and K_W receives the predetermined calibration strength S1 of 70 g, the sum of the generated calibration sensing value (I measurement) plus the compensation value (I compensation) is equal to the threshold TH1 being 0.7 A. The compensation value can compensate the current difference caused by the difference between the different overall equivalent impedance values of different keys. Then, during normal operation of the keyboard, the difference between different impedance values of different keys can be compensated by the sum of the current sensing value (digit value) generated when a key is pressed plus the compensation value.

As indicated in Table 3, when each of the keys K_{—}1, K_Q and K_W receives a strength S2 of 80 g higher than the predetermined calibration strength of 70 g, the measured current of each key is increased, such that the compensated digit value I_total of each key (that is, the compensated digit value I_total is equal to I measurement plus I compensation) is higher than the threshold TH1. Then, the micro-processor 44 determines that all the three keys K_{—}1, K_Q and K_W are pressed.

As indicated in Table 4, when each of the keys K_{—}1, K_Q and K_W receives a strength S3 of 60 g lower than the predetermined calibration strength of 70 g, the measured current of each of the keys is decreased, such that the compensated digit value I_total of each key (that is, the compensated digit value I_total is equal to I measurement plus I compensation) is lower than the threshold TH1. Then, the micro-processor 44 determines that none of the three keys K_{—}1, K_Q and K_W is pressed.

TABLE 3

| | Key 1 | Key Q | Key W |
|---|---|---|---|
| Vcc | 6 | 6 | 6 |
| I measurement | 0.66 | 0.54 | 0.42 |
| I compensation | 0.1 | 0.2 | 0.3 |
| I_total | 0.76 | 0.74 | 0.72 |
| TH1 | 0.7 | 0.7 | 0.7 |
| Judgment | Conducted | Conducted | Conducted |

TABLE 4

| | Key 1 | Key Q | Key W |
|---|---|---|---|
| Vcc | 6 | 6 | 6 |
| I measurement | 0.54 | 0.46 | 0.375 |
| I compensation | 0.1 | 0.2 | 0.3 |
| I_total | 0.64 | 0.66 | 0.65 |
| TH1 | 0.7 | 0.7 | 0.7 |
| Judgment | Not conducted | Not conducted | Not conducted |

If the user would like to adjust the magnitude of the conducting strength of a key, the adjustment can be achieved by changing the current threshold of the key. The user can input a threshold adjustment request through a keyboard driver or an application program. In response to the threshold adjustment request, the keyboard controller can increase or decrease the current threshold, and then determine whether a key is pressed according to the updated current threshold.

Refer to FIG. 9 and Table 5. FIG. 9 is a schematic diagram of compensated digit value of each of the keys obtained after the user increased the current threshold to threshold TH2 (0.8 A) and applied a force of 80 g on each of the keys K_{—}1, K_Q and K_W. As indicated in FIG. 9 and Table 5, when each of the keys K_{—}1, K_Q and K_W receives a force of 80 g, current values D1′, D2′ and D3′ of the keys K_{—}1, K_Q and K_W can be obtained respectively. The compensated digit values of the keys K_{—}1, K_Q and K_W are 0.76 A, 0.74 A and 0.72 A, respectively. Since all the three digit values are lower than the threshold TH2 (0.8 A), the keyboard controller determines that none of the three keys is pressed, and will not output any key codes corresponding to the three keys to the host. Thus, when the user presses the keys with the same force of 80 g, all the three keys are determined as ‘conducted’ given that the threshold is the predetermined threshold TH1 (0.7 A) as indicated in Table 3, all the three keys are determined as ‘not conducted’ given that the current threshold is increased to threshold TH2 (0.8 A) as indicated in Table 5.

TABLE 5

| | Key 1 | Key Q | Key W |
|---|---|---|---|
| Vcc | 6 | 6 | 6 |
| I measurement | 0.66 | 0.54 | 0.42 |
| I compensation | 0.1 | 0.2 | 0.3 |
| I_total | 0.76 | 0.74 | 0.72 |
| TH2 | 0.8 | 0.8 | 0.8 |
| Judgment | Not conducted | Not conducted | Not conducted |

TABLE 6

| | Key 1 | Key Q | Key W |
|---|---|---|---|
| Vcc | 6 | 6 | 6 |
| I measurement | 0.54 | 0.46 | 0.375 |
| I compensation | 0.1 | 0.2 | 0.3 |
| I_total | 0.64 | 0.66 | 0.65 |
| TH3 | 0.6 | 0.6 | 0.6 |
| Judgment | Conducted | Conducted | Conducted |

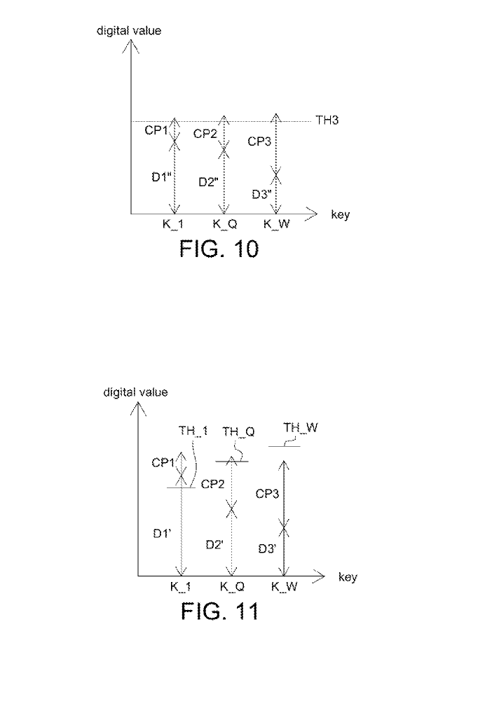

Refer to FIG. 10 and Table 6. FIG. 10 is a schematic diagram of compensated digit value of each of the keys obtained after the user decreased the current threshold to threshold TH2 (0.6 A) and applied a force of 60 g on each of the keys K_{—}1, K_Q and K_W. As indicated in FIG. 10 and Table 6, when each of the keys K_{—}1, K_Q and K_W receives a force of 60 g, the current values D1″, D2″ and D3″ of the three keys K_{—}1, K_Q and K_W are obtained, and the compensated digit values of the three keys are 0.64 A, 0.66 A and 0.65 A, respectively. Since all the digit value are higher than the threshold TH3 (0.6 A), the keyboard controller determines that all the three keys are pressed, and outputs key codes corresponding to the three keys to the host. Thus, when the user presses the keys with the same force of 60 g, all the three keys are determined as ‘not conducted’ given that the threshold is the predetermined threshold TH1 as indicated in Table 4, and all the three keys are determined as ‘conducted’ under the circumstance that the current threshold is decreased to threshold TH3 as indicated in Table 6. Besides, if the user only would like to adjust the forces of some of the keys, corresponding threshold of each key is stored, and the thresholds of particular keys are changed. The user can input a threshold adjustment request through a keyboard driver or an application program. In response to the threshold adjustment request, the keyboard controller can increase or decrease the current threshold, and then determine whether a key is pressed according to the updated current threshold.

Refer to FIG. 11 and Table 7. FIG. 11 is a schematic diagram of compensated digit values obtained after a force of 80 g is applied on each of the keys K_{—}1, K_Q and K_W when the keys K_{—}1, K_Q and K_W have different thresholds such as TH_{—}1 (0.6 A), TH_Q (0.7 A), TH_W (0.8 A). As indicated in FIG. 11 and Table 7, when each of the keys K_{—}1, K_Q and K_W receives a force of 80 g, current values D1′, D2′ and D3′ of the keys K_{—}1, K_Q and K_W can be obtained respectively. The compensated digit values of the keys K_{—}1, K_Q and K_W are 0.76 A, 0.74 A, 0.72 A, respectively. Since the digit values of the keys K_{—}1 and K_Q are higher than the thresholds TH_{—}1 (0.6 A) and TH_Q (0.7 A) respectively, the keyboard controller determines that the two keys are pressed. Since the digit value of key K_W is lower than the threshold TH_W (0.8 A), the keyboard controller determines that the key W is not pressed. The keyboard controller will output to the host only the key codes corresponding to the keys K_{—}1 and K_Q but not the key code corresponding to the key K_W. Thus, the user's specific requests can be satisfied: (1) a weak force would suffice to conduct the keys K_{—}1 and K_Q; (2) a strong force is required for conducting the key K_W.

TABLE 7

| | Key 1 | Key Q | Key W |
|---|---|---|---|
| Vcc | 6 | 6 | 6 |
| I measurement | 0.66 | 0.54 | 0.42 |
| I compensation | 0.1 | 0.2 | 0.3 |
| I_total | 0.76 | 0.74 | 0.72 |
| Threshold | TH_1 = 0.6 | TH_Q = 0.7 | TH_W = 0.8 |
| Judgment | Conducted | Conducted | Not conducted |

Given that the architecture of FIGS. 5A-5B is used, as indicated in Table 3, when the key K_{—}1 is pressed by a force F0 (70 g), the first paths L0 and L1 correspondingly transmit a first signal. When the key K_Q is pressed by the force F0, the second paths L2 and L3 correspondingly transmit a second signal. The keyboard controller stores a first compensation value I_compensation 1 (0.1 A) and a second compensation value I_compensation Q (0.2 A) a first key code “1” and a second key code “Q”, and further uses the threshold TH1 (0.7 A) as an actuation threshold. The keyboard controller is capable of extracting a first signal value I measurement 1 from the first signal and extracting a second signal value I measurement Q from the second signal. When the keyboard controller receives the first signal from the first paths L0 and L1 and the sum of the first signal value I measurement 1 plus the first compensation value I_compensation 1 (0.1 A) satisfies the actuation threshold TH1 (0.7 A), the keyboard controller outputs the first key code “1” to a host (not illustrated) in response to the first signal. When the keyboard controller receives the second signal from the second paths L2 and L3 and the sum of the second signal value I measurement Q plus the second compensation value I_compensation Q (0.2 A) satisfies the actuation threshold TH1 (0.7 A), the keyboard controller outputs the second key code “Q” to the host in response to the second signal.

As indicated in Table 5, when the actuation threshold is increased to TH2 (0.8 A) according to a user's adjustment such that the sum of the first signal value I measurement 1 plus the first compensation value I_compensation 1 cannot satisfy the adjusted actuation threshold TH2 (0.8 A), the keyboard controller ignores the first signal and does not output the first key code “1” to the host.

As indicated in Table 4, when the first key is pressed by a second force (60 g), the first path correspondingly transmits a third signal. The second force is lower than the first force. The keyboard controller is capable of extracting a third signal value I measurement 1 (0.54 A) from the third signal. When the keyboard controller receives the third signal from the first path and uses the threshold TH1 (0.7 A) as the actuation threshold, and the sum of the third signal value (0.54 A) and the first compensation value (0.1 A) cannot satisfy the actuation threshold TH1 (0.7 A), the keyboard controller ignores the third signal and does not output the first key code “1” to the host.

As indicated in Table 6, when the actuation threshold is decreased to the threshold TH3 (0.6 A) according to a user's adjustment such that the sum of the third signal value (0.54 A) plus the first compensation value (0.1 A) satisfies the adjusted actuation threshold TH3 (0.6 A), the keyboard controller outputs the first key code “1” to the host in response to the third signal.

The variable resistor can be realized by a plurality of switch contact points disposed under the first key. When the first key is pressed by the first force, M units of the plurality of switch contact points are conducted. When the first key is pressed by the second force, N units of the plurality of switch contact points switch contact points are conducted, M is bigger than N. Thus, the first current value is higher than the third current value.

For example, as indicated in FIG. 2B, the said switch contact points can be realized by a plurality of sub-contact points. Suppose 5 switch contact points are conducted when the key 100 is pressed by a first force (a strong force). Suppose 2 switch contact points are conducted when the key 100 is pressed by a second force (a weak force). When the key 100 is pressed by the first force, the key 100 will have a smaller equivalent resistance because more switch contact points are conducted and more resistors are connected in parallel. Therefore, the first current value of the key pressed by the first force is higher than the third current value of the key pressed by the second force.

In another embodiment, the keyboard can be divided into different groups, such that the keys in a particular region of the keyboard can have specific settings according to the user's special needs. For example, as indicated in FIG. 1, the user may prefer to allow some frequently used keys such as the four direction keys “↑”, “↓”, “←”, “→” to have higher sensitivity.

The above mentioned methods can also be used for the user to transmit a corresponding key code by lightly pressing a key. Firstly, all the keys on the keyboard 10 are corrected, and actuation thresholds corresponding to the four frequently used direction keys “↑”, “↓”, “←”, “→” are adjusted. For example, the actuation thresholds of the four keys can be set to a small values. Therefore, although the four keys are pressed by a weak force, the computation result of the digit values of the keys and the compensation values of the four keys still can satisfy the actuation threshold and corresponding key codes still can be outputted. Through such arrangement, the sensitivity of the four keys can be increased. Conversely, if the actuation thresholds of the four keys are set to a large value, the four keys must be pressed by a stronger force for the computation result of the digit values and the compensation values of the four keys to satisfy the actuation threshold. Under such circumstance, the user needs to press the four keys hardly for corresponding key codes to be outputted. Thus, the four keys have lower sensitivity.

The conducting strengths of other keys can be changed through the adjustment in corresponding actuation thresholds. The present embodiment allows the user to flexibly divide the keys on the keyboard into different groups according to the user's needs and to adjust corresponding actuation thresholds to set the conducting strengths of the keys. Through the above arrangements of the embodiments of the invention, the user can enjoy better experience of use when the user is typing or executing other application programs (such as computer games).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard, comprising:
a plurality of keys comprising a first key; and
a keyboard controller for generating a first sensing value corresponding to the first key when the first key is pressed by a first force, wherein the first sensing value is related to the magnitude of the first force and is compensated by a first compensation value corresponding to the first key to generate a first adjusted sensing value;
wherein the first adjusted sensing value is higher than or equal to a current threshold, the keyboard controller determines whether the first key is pressed, and outputs a first key code corresponding to the first key.

2. The keyboard according to claim 1, wherein the first compensation value is 0 or a negative value.

3. The keyboard according to claim 1, wherein each of the keys comprises a piezoresistive material component, the impedance value of the piezoresistive material component of the first key is related to the magnitude of the first force, such that the first sensing value is related to the magnitude of the first force.

4. The keyboard according to claim 1, wherein each of the keys comprises a plurality of sub-contact points, and the number of conducted sub-contact points of the first key is related to the magnitude of the first force.

5. The keyboard according to claim 1, wherein the keys are respectively pressed by a predetermined calibration strength, the keyboard controller generates a plurality of calibration sensing values respectively corresponding to the keys in response to the predetermined calibration strengths of the keys; and
compares the calibration sensing values with a calibration threshold to generate a plurality of compensation values corresponding to the keys respectively, wherein the compensation values comprise the first compensation value.

6. The keyboard according to claim 5, wherein a sum of the compensation value of each of the keys and the calibration sensing values corresponding to the keys is substantially equal to the calibration threshold.

7. The keyboard according to claim 5, wherein the calibration threshold is used as the current threshold.

8. The keyboard according to claim 1, wherein, the keyboard controller further changes the value of the current threshold in response to a request for adjusting key force.

9. A keyboard capable of adjusting key conducting strength according to a user operation, wherein the keyboard comprises:
a plurality of keys comprising a first key; and
a keyboard controller for generating a first sensing value corresponding to the first key when the first key is pressed by a first force and compensating the first sensing value by a first compensation value corresponding to the first key to generate a first adjusted sensing value;
wherein, the keyboard controls an actuation threshold of the first key through the adjustment of a current threshold;
wherein, the keyboard outputs a first key code corresponding to the first key when the first adjusted sensing value is higher than or equal to the actuation threshold.

10. The keyboard according to claim 9, wherein the keyboard is controlled by an electronic device which executes an application program to adjust the current threshold.

11. The keyboard according to claim 9, wherein the first sensing value is related to the magnitude of the first force, and if the keyboard controller determines that the first adjusted sensing value is higher than or equal to the actuation threshold, the keyboard controller determines that the first key is pressed and accordingly outputs the first key code corresponding to the first key.

12. The keyboard according to claim 9, wherein each of the keys contains a piezoresistive material component, the impedance value of the piezoresistive material component of the first key is related to the magnitude of the first force, such that the first sensing value is related to the magnitude of the first force.

13. The keyboard according to claim 9, wherein each of the keys comprises a plurality of sub-contact points, and the number of conducted sub-contact points of the first key is related to the magnitude of the first force.

14. A keyboard, comprising:
a first key;
a first path, when the first key is pressed by a first force, the first path correspondingly transmits a first signal;
a second key;
a second path, when the second key is pressed by the first force, the second path correspondingly transmits a second signal; and
a keyboard controller storing a first compensation value, a second compensation value, an actuation threshold, a first key code and a second key code, capable of extracting a first signal value and a second signal value from the first signal the second signal respectively;
wherein when the keyboard controller receives the first signal from the first path and the computation result of the first signal value and the first compensation value satisfies the actuation threshold, the keyboard controller outputs the first key code to a host in response to the first signal;
wherein when the keyboard controller receives the second signal from the second path and the computation result of the second signal value and the second compensation value satisfies the actuation threshold, the keyboard controller outputs the second key code to the host in response to the second signal.

15. The keyboard according to claim 14, wherein when the actuation threshold is adjusted by a user, such that the computation result of the first signal value and the first compensation value cannot satisfy the adjusted actuation threshold, the keyboard controller ignores the first signal and does not output the first key code to the host.

16. The keyboard according to claim 14, wherein
when the first key is pressed by a second force, the first path correspondingly transmits a third signal, and the second force is lower than the first force;
the keyboard controller is capable of extracting a third signal value from the third signal;
wherein when the keyboard controller receives the third signal from the first path and the computation result of the third signal value and the first compensation value cannot satisfy the actuation threshold, the keyboard controller ignores the third signal and does not output the first key code to the host.

17. The keyboard according to claim 16, wherein when the actuation threshold is adjusted by a user, such that the computation result of the third signal and the first compensation value satisfies the adjusted actuation threshold, the keyboard controller outputs the first key code to the host in response to the third signal.

18. The keyboard according to claim 16, wherein the first path further comprises a variable resistor coupled between the first key and the first path,
when the first key is pressed by the first force, the variable resistor has a lower resistance, such that the first signal contains a first current value;
when the first key is pressed by the second force, the variable resistor has a higher resistance such that the third signal contains a third current value, and the first current value is higher than the third current value;
the actuation threshold is a predetermined current value;
wherein when a sum of the first current value and the first compensation value is higher than the predetermined current value, the keyboard controller outputs the first key code to the host in response to the first current value;
wherein when a sum of the third current value and the first compensation value is lower than the predetermined current value, the keyboard controller ignores the third current value and does not output the first key code to the host.

19. The keyboard according to claim 18, wherein the variable resistor is a plurality of switch contact points disposed under the first key, M units of the plurality of switch contact points are conducted when the first key is pressed by the first force, N units of the plurality of switch contact points are conducted when the first key is pressed by the second force, and M is bigger than N, such that the first current value is higher than the third current value.

20. The keyboard according to claim 14, wherein the first compensation value and the second compensation value is obtained from the calculation of a calibration procedure comprising:
(1) pressing the first key and the second key respectively by a testing force, such that the first key and the second key respectively output the first signal value and the second signal value both lower than the actuation threshold;
(2) deducting the actuation threshold by the first signal value to obtain the first compensation value; and
(3) deducting the actuation threshold by the second signal value to obtain the second compensation value.
